(19) United States
(12) Patent Application Publication
(10) Pub. No.: US 2011/0047757 A1
(43) Pub. Date: Mar. 3, 2011

(54) Child Training Grip

(76) Inventor: Edgardo Zapanta, San Bruno, CA (US)

(21) Appl. No.: 12/552,257

(22) Filed: Sep. 1, 2009

(51) Int. Cl. B25G 1/10; G09B 19/24

(52) U.S. Cl. 16/421; 434/260

(57) ABSTRACT

A method and device for teaching a young child how to use utensils comprising obtaining a training utensil handle grip having an elongated and hollow body portion shaped like an animated character with two arms stretching outward, inserting the back end of a utensil into hollow tubular opening from the the front end of the training utensil handle grip, permitting the young child to visualize the hands of the character associated with the training utensil handle grip grasping the utensil, and allowing the young child to emulate the character and grasp the training utensil handle grip, thereby teaching and reinforcing the technique of using utensils.

### RELATED APPLICATIONS

None.

### FIELD OF THE INVENTION

The invention relates to a detachable handle grip for elongated utensils such as forks, spoons, toothbrushes, etc., for children, and more particularly to an educational method and device for teaching children the correct way to hold an elongated utensil or similar object.

### BACKGROUND OF THE INVENTION

Young children usually start to learn how to hold and use an elongated utensil such as a spoon, crayon, fork etc., when they are toddlers between about 12 and 14 months old. Often parents let toddlers attempt to hold regular utensils or utensils of smaller sizes. There are numerous utensils designed specially for toddlers available in the marketplace today, however in general they are regular utensils made in a smaller size to better fit a young child's hand or hands.

As shown in FIG. 1A, there is a typical example of a prior art spoon 94 designed for toddlers. There is a grip 90 wrapping the handle to make it easier for toddlers to grasp. FIG. 1B is another example of a pencil 92 with a handle grip 96 of the prior art Colorful decorations are usually added to those grips to attract and keep the attention of toddlers, but have no other real function. Grips are usually made with soft, non-toxic and non-slippery materials.

Unfortunately, the devices and methods of the prior art fail to actually teach a child how to use the utensil, i.e., by grabbing it with their hands. None of the devices or methods of the prior art include a graphic or 3-dimensional, sculptural depiction of how to use a utensil.

There exists a need for a multi-functional, educational and adaptable training grip for toddlers and young children to help them learn the correct way to hold utensils such as spoons, forks, pencils, etc.

### ADVANTAGES AND SUMMARY OF THE INVENTION

It is an object and advantage of the present invention to provide a handle grip that is a better fit to toddlers' hand.

It is another object and advantage of the present invention to provide a comfortable grasp to toddlers of elongated utensils and prevent them from slipping off their hands.

It is yet another object and advantage of the present invention to provide a motivation, interaction and interest for toddlers to learn to use certain utensils.

It is yet a further object and advantage of the present invention to provide a graphic or 3-dimensional, sculptural depiction of how to hold a utensil in order to teach, remind and reinforce the method.

Numerous other advantages and features of the present invention will become readily apparent from the following detailed description of the invention and the embodiments thereof, from the claims and from the accompanying drawings.

### BRIEF DESCRIPTION OF THE DRAWINGS

FIG. 1A (prior art) is a representative isometric view of application of handle grip 90 on a spoon 94.

FIG. 1B (prior art) a representative isometric view of application of another type of handle grip 96 on a pencil 92.

FIG. 2A is a representative isometric view of application of child training grip 100 on a spoon 94.

FIG. 2B a representative isometric view of application of another type of grip handle 96 on a pencil 96.

FIGS. 3A, 3B, 3C, 3D and 3E are the representative side view, top view, cross-sectional view, front end view and back end view, respectively, of child training grip 100 of present invention.

FIG. 4 is a representative view showing child training grip 100 of present invention standing on its back end 120.

FIGS. 5A, 5B and 5C are representative views showing rotatable head portion 110 in different positions.

FIG. 6 is a representative view of application showing child training grip 100 of present invention holding different utensils and objects.

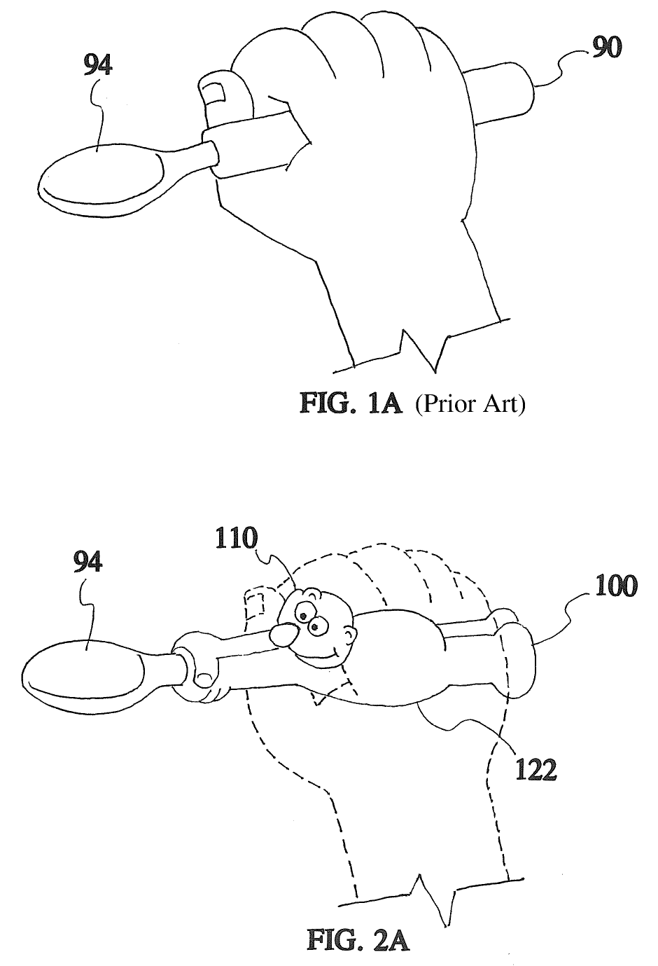

### DETAILED DESCRIPTION OF THE PREFERRED EMBODIMENT

The description that follows is presented to enable one skilled in the art to make and use the present invention, and is provided in the context of a particular application and its requirements. Various modifications to the disclosed embodiments will be apparent to those skilled in the art, and the general principals discussed below may be applied to other embodiments and applications without departing from the scope and spirit of the invention. Therefore, the invention is not intended to be limited to the embodiments disclosed, but the invention is to be given the largest possible scope which is consistent with the principals and features described herein.

It will be understood that in the event parts of different embodiments have similar functions or uses, they may have been given similar or identical reference numerals and descriptions. It will be understood that such duplication of reference numerals is intended solely for efficiency and ease of understanding the present invention, and are not to be construed as limiting in any way, or as implying that the various embodiments themselves are identical.

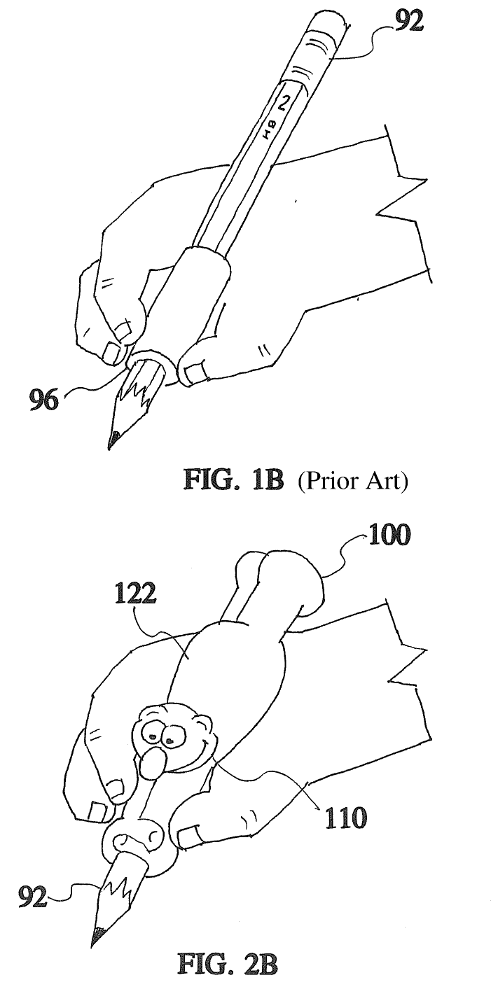

FIG. 2A is a representative view of application of child training grip 100 on a spoon 94. FIG. 2B a representative view of application of child training grip 100 on a pencil 92. As shown in FIG. 2A and FIG. 2B, child training grip 100 of the present invention is flexible and adaptable to be applied on utensils of different lengths, types, modes of holding. For example, as shown in FIG. 2A, toddler is learning to use a spoon 94 with the present invention 100 whereas in FIG. 2B, the same child training grip 100 is being used on a pencil.

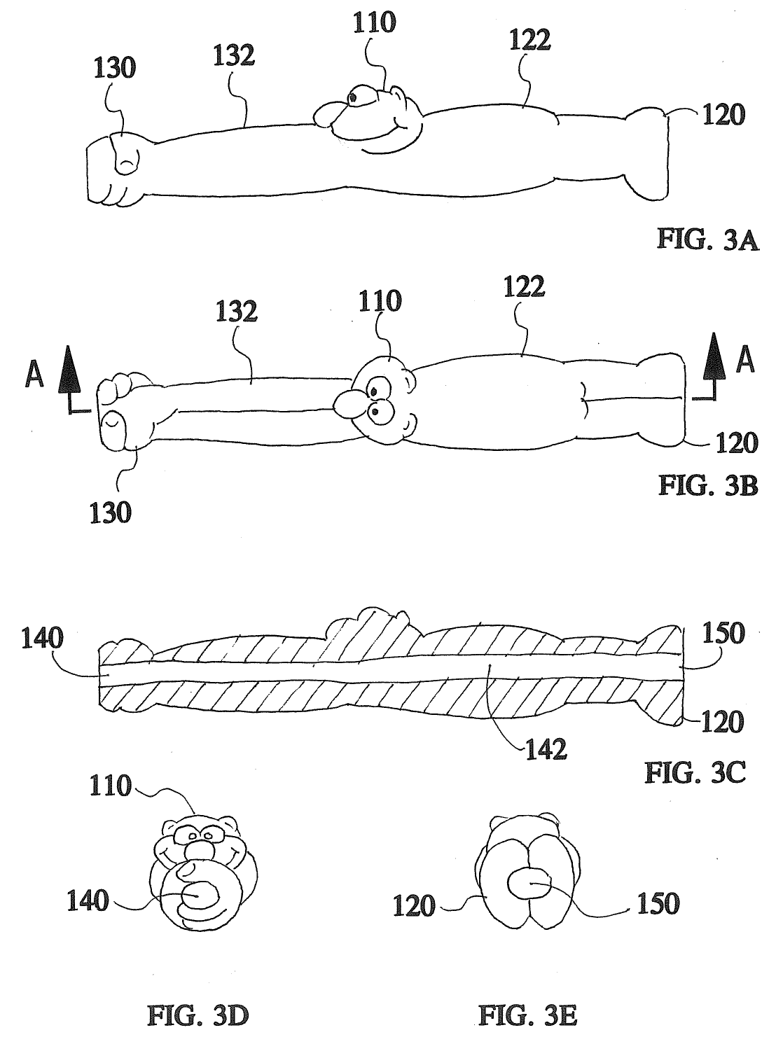

FIGS. 3A, 3B, 3C, 3D and 3E are the representative side view, top view, cross-sectional view, front end view and back end view, respectively, of child training grip 100 of present invention. As shown in FIG. 3A, child training grip 100 of the present invention is an elongated structure consists of hands 130 on one end and back end 120 on another end and arms 132, head 110 and torso 122 in between. Child training grip 100 is made of soft, non-slippery, non-toxic material such as polyurethane foam, rubber vinyl, high density rubber. In an embodiment of the invention, the material for the handle is flexible “PU” or “Polyurethane” foam, rubber vinyl, high density rubber. See.http://officeplayground.com/foamstresstoys.html for a description of the material used in an embodiment of the present invention. This type of “polyurethane” material is soft flexible and can be finished using silkscreen, paint, decal etc.

In one embodiment, it is relatively easy to add colors and mold the material of construction into different shapes. In one embodiment, child training grip 100 looks like an animal, only as an example, stretching out its two arms to hold on to an object. In other alternative embodiments, child training grip 100 can be made into any character, animal, creature, and even copyrighted characters for promotional purposes. As best shown in FIG. 3B, arms 132 are stretched out and hands 130 are held together as if they are gripping a utensil. Arms 132 are optionally elongated to provide space for toddler to place their fingers especially when child training grip 100 is used on writing utensils such as a pencil.

As shown best in FIG. 3C, an opening such as a tunnel, aperature or other tubular opening 142 runs through the entire length of child training grip 100 of the present invention. The function of tubular opening 142 is to accommodate the handle part of elongated utensils such as tooth brush, spoon, fork, pen, crayon etc. that are used on the child training grip 100. With flexible building material, tubular opening 142 having a predetermined dimension or shape can accommodate utensils of different girths and shapes and still provide a tight fit. As shown in FIG. 3D, handle of utensil is inserted through hand opening 140. As shown in FIG. 3E, back opening 150 is optionally but preferably left opened to provide easy cleaning, venting and/or drainage of the tubular opening 142 if necessary.

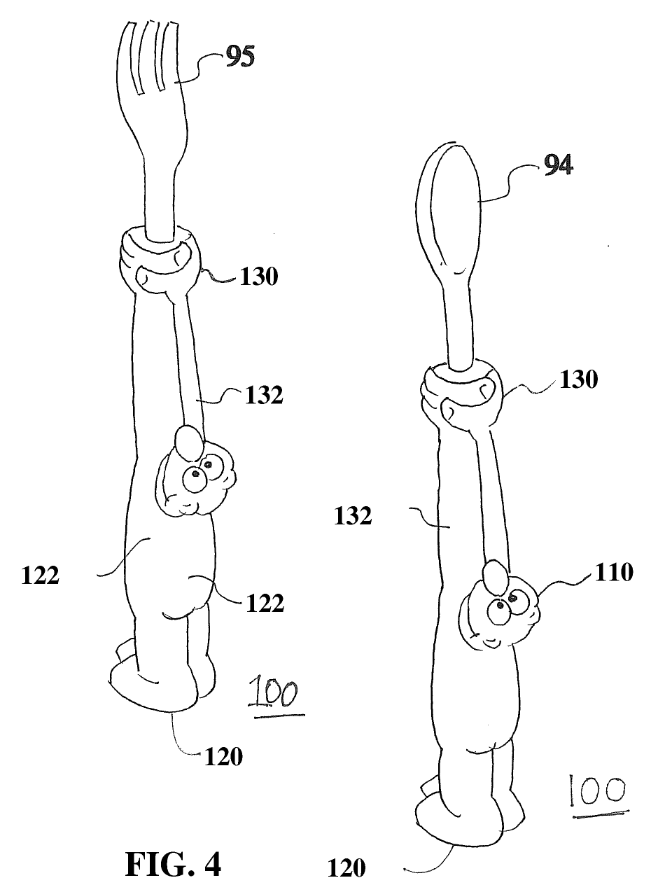

FIG. 4 is a representative view showing child training grip 100 of present invention standing on its back end 120. As shown in FIG. 4, back end 120 is flat such as the entire child training grip 100 child training grip 100 can stand on its own. In one embodiment, different utensils such as a spoon 94 or a fork 95 can be inserted to the child training grip 100 to make it instantly suitable for toddlers to use. As best shown in FIGS. 2A and 2B, toddler's hand grasps on the torso 122 and is prevented from slipping forward by head 110. Child training grip 100 can be temporarily applied to utensils to provide a comfortable fitting grip for toddlers or permanently. As best shown in FIG. 4, once the handle of utensil is inserted in the child training grip 100, it looks like the character that is featured as child training grip 100 of the present invention is holding the utensil. It can provide interaction and education to toddlers using the child training grip 100 how to hold the utensil correctly.

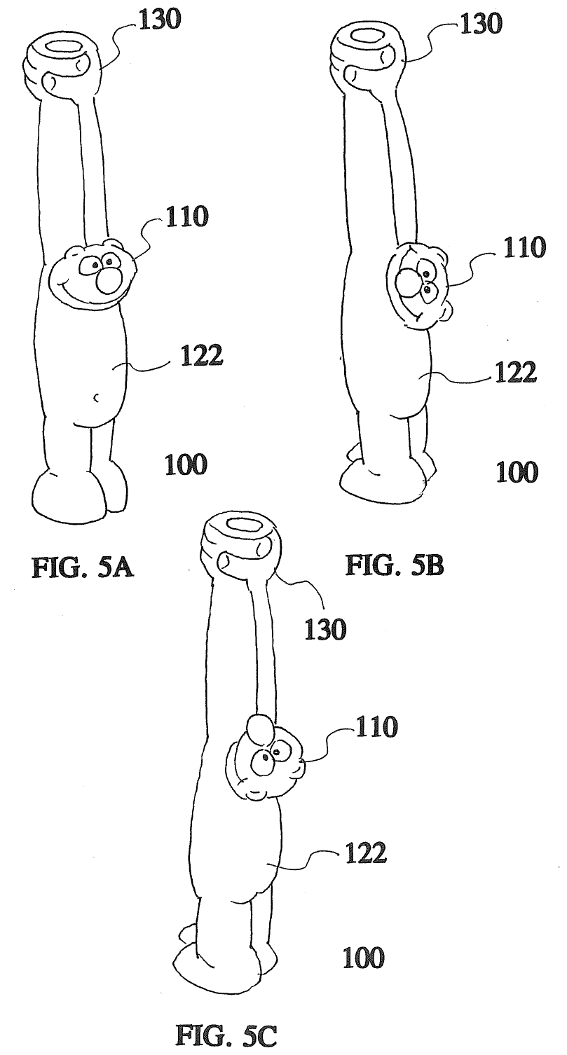

FIGS. 5A, 5B and 5C are representative views showing rotatable head portion 110 in different positions. In one embodiment, head 110 of child training grip 100 attached to torso 122 with a hinge such that head 110 can be rotated 360 degrees as best shown in FIGS. 5A, 5B and 5C. Anatomical head portions 110 of characters used on child training grip 100 can be positioned facing towards the toddler as in FIG. 5A, sideway as in FIG. 5B and hands 130 as in FIG. 5C and still serves the purpose of locking the position of toddler's hand.

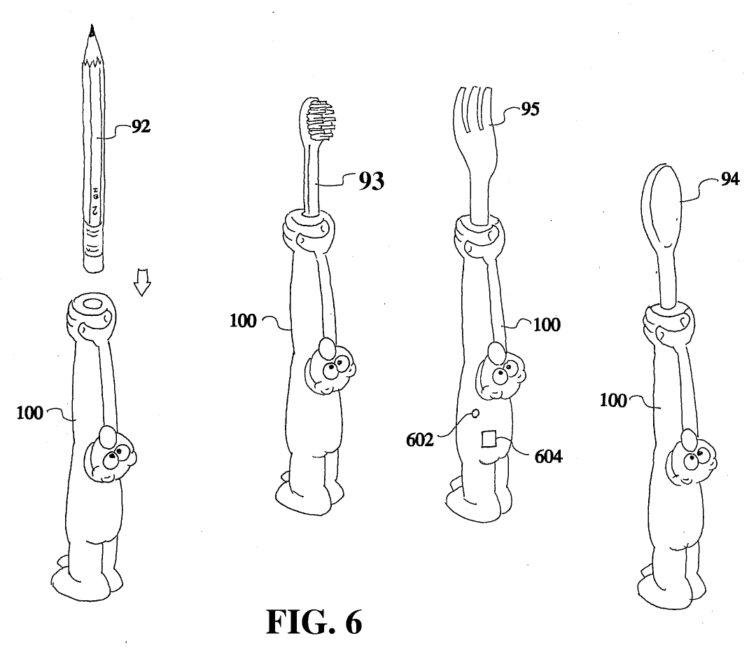

FIG. 6 is a representative view of application showing child training grip 100 of present invention holding different utensils and objects. In alternative embodiments, child training grip 100 can be made with different colors, textures and softness. Or it can be made into different characters to spark toddlers' interest. It can also incorporate sound effects by installing an music box embodiment 604 which is triggered by button 602. When toddler holds child training grip 100 and push button 602, music box embodiment 604 is switched on. Or child training grip 100 can be made with transparent material with LED built in which is also triggered by button 602.

Unless defined otherwise, all technical and scientific terms used herein have the same meaning as commonly understood by one of ordinary skill in the art to which the present invention belongs. Although any methods and materials similar or equivalent to those described can be used in the practice or testing of the present invention, the preferred methods and materials are now described. All publications and patent documents referenced in the present invention are incorporated herein by reference.

While the principles of the invention have been made clear in illustrative embodiments, there will be immediately obvious to those skilled in the art many modifications of structure, arrangement, proportions, the elements, materials, and components used in the practice of the invention, and otherwise, which are particularly adapted to specific environments and operative requirements without departing from those principles. The appended claims are intended to cover and embrace any and all such modifications, with the limits only of the true purview, spirit and scope of the invention.

I claim:

1. A training utensil handle grip for training children how to use utensils, the training utensil handle grip comprising:
an elongated and hollow body portion shaped like an animated character with two arms stretching outward, the body portion further having a back end shaped like two feet and a front end shaped like two hands grasping a utensil, the body further comprising an animated head portion attached to the body portion; and
a hollow, tubular opening extending from the back end to the second end, the opening adapted for securely receiving a hand-held utensil.

2. The training utensil handle grip for children of claim 1 in which the body portion is made of a material selected from the group consisting of polyurethane foam, rubber vinyl, high density rubber, and flexible polyurethane foam.

3. The training utensil handle grip for children of claim 1 in which the animated character is selected from the group consisting of cartoon animals, cartoon characters, superheroes, other action figures, fairy tale characters, religious characters, historical characters, political characters, actors, musicians, movies stars and celebrities.

4. The training utensil handle grip for children of claim 1 in which the head is attached to the body by a hinge allowing 360 degree rotation.

5. The training utensil handle grip for children of claim 1 in which the tubular opening further has a circular cross-section.

6. The training utensil handle grip for children of claim 1 in which a music box is installed within the body portion.

7. The training utensil handle grip for children of claim 1 in which at least one LEDs are installed inside the body portion.

8. A method for teaching a young child how to use utensils utilizing a training utensil handle grip, the method comprising the following steps:
obtaining a training utensil handle grip having (a) an elongated and hollow body portion shaped like an animated character with two arms stretching outward, the body portion further having a back end shaped like two feet and a front end shaped like two hands grasping a utensil, the body further comprising an animated head portion attached to the body portion, and (b) a hollow, tubular opening extending from the back end to the second end, the opening adapted for securely receiving a hand-held utensil;
inserting the back end of a utensil into hollow tubular opening from the front end of the training utensil handle grip;
permitting the young child to visualize the hands of the character associated with the training utensil handle grip grasping the utensil; and
encouraging the young child to emulate the character and grasp the training utensil handle grip, thereby teaching and reinforcing the technique of using utensils.

9. A method for teaching a young child how to use utensils comprising the steps of obtaining a training utensil handle grip having an elongated and hollow body portion shaped like an animated character with two arms stretching outward, inserting the back end of a utensil into hollow tubular opening from the front end of the training utensil handle grip, permitting the young child to visualize the hands of the character associated with the training utensil handle grip grasping the utensil, and allowing the young child to emulate the character and grasp the training utensil handle grip, thereby teaching and reinforcing the technique of using utensils.
